(19) United States
(12) Patent Application Publication
(10) Pub. No.: US 2006/0198632 A1
(43) Pub. Date: Sep. 7, 2006

(54) Image capturing system, interchangeable lens, image capturing apparatus and IC tag

(75) Inventor: Yasuhiro Kingetsu, Osaka (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/258,357

(22) Filed: Oct. 25, 2005

(30) Foreign Application Priority Data
Mar. 4, 2005 (JP) JP2005-60361

(51) Int. Cl. G03B 17/00

(52) U.S. Cl. 396/529

(57) ABSTRACT

An image capturing system comprises a camera body provided with an IC tag reader, and an interchangeable lens capable of being attached to and detached from the camera body. The interchangeable lens is provided with an IC tag storing information for example about shading correction of the interchangeable lens. When the interchangeable lens is attached to the camera body in this image capturing system, the IC tag reader reads the stored information from the IC tag for use in shading correction. Thus the use of the IC tag facilitates processing corresponding to an interchangeable lens.

This application is based on application No. 2005-60361 filed in Japan, the contents of which are hereby incorporated by reference.

### BACKGROUND OF THE INVENTION

1. Field of the Invention

The present invention relates to a technique involving an image capturing system to and from which an interchangeable lens can be attached and detached.

2. Description of the Background Art

A device so-called IC tag has been developed and received much attention. This IC tag is formed by an IC (integrated circuit) chip with each side for example of 1 mm or less, storing information readable by radio communication. Various uses of this tag have been suggested as introduced for example in Japanese Patent Application Laid-Open No. 2001-145173.

In contrast to a film camera, the use of a digital camera (image capturing system) allows digital correction (such as shading correction) for compensating for image degradation caused by a lens.

However, in such a digital camera to which an interchangeable lens for a film camera is attached, the correction information of this interchangeable lens cannot be obtained. Hence processing such as shading correction corresponding to an interchangeable lens is hard to perform.

More specifically, a conventional film camera is incapable of performing digital image processing such as shading correction. That is, there is no importance for an interchangeable lens to hold correction information unique to itself. Such correction information is not actually stored for example in an ROM inside the interchangeable lens. Thus in the digital camera equipped with this interchangeable lens of the film camera, information about shading correction and the like cannot be obtained from the interchangeable lens, thereby failing to effectively use the correcting function of the digital camera.

On the other hand, the foregoing IC tag if storing information about shading correction and the like may be applied for realizing suitable correction using the correcting function of the digital camera.

### SUMMARY OF THE INVENTION

The present invention is intended for an image capturing system.

According to the present invention, the image capturing system comprises: an interchangeable lens provided with an IC tag storing specific information; and an image capturing apparatus to and from which the interchangeable lens can be attached and detached. The image capturing apparatus includes a reader for reading the specific information from the IC tag, and a processor responsible for predetermined processing based on the specific information read by the reader.

Thus the use of the IC tag facilitates processing corresponding to an interchangeable lens.

Preferably, in this image capturing system, the specific information is correction information of the interchangeable lens, and the processor includes a correcting part responsible for correction based on the correction information.

Thus correction corresponding to an interchangeable lens can be suitably performed.

The present invention is also directed to an interchangeable lens, an image capturing apparatus, and IC tag.

It is therefore an object of the present invention to provide a technique involved in an image capturing apparatus capable of facilitating processing corresponding to an interchangeable lens using an IC tag.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 and 2 are external views of an image capturing system according to a first preferred embodiment of the present invention;

FIG. 3 is a sectional view with respect to III-III of FIG. 1;

FIG. 4 is a functional block diagram of the image capturing system;

FIG. 5 is a flow chart showing the basic operation of the image capturing system;

FIG. 6 is a flow chart showing the flow of processes with a lens attached in the image capturing system;

FIG. 7 shows field curvature data stored in an IC tag in an image capturing system according to a second preferred embodiment of the present invention;

FIG. 8 shows default field curvature data; and

FIG. 9 is a flow chart showing the flow of processes with a lens attached in the image capturing system.

### DESCRIPTION OF THE PREFERRED EMBODIMENTS

### First Preferred Embodiment

<Overview of Image Capturing System>

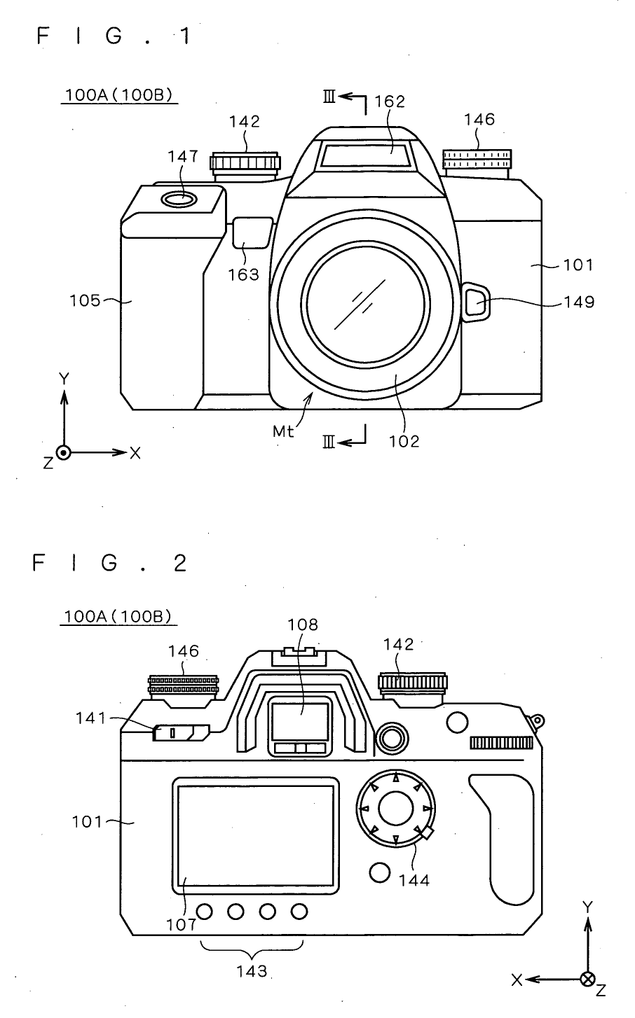

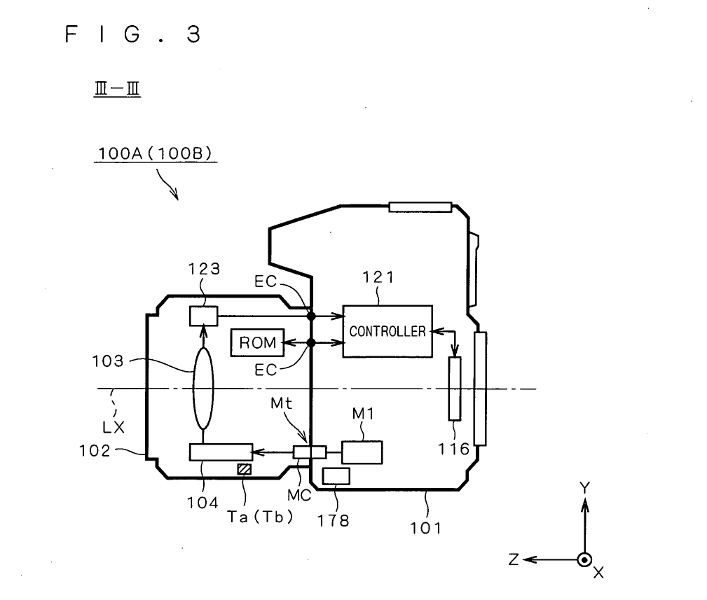

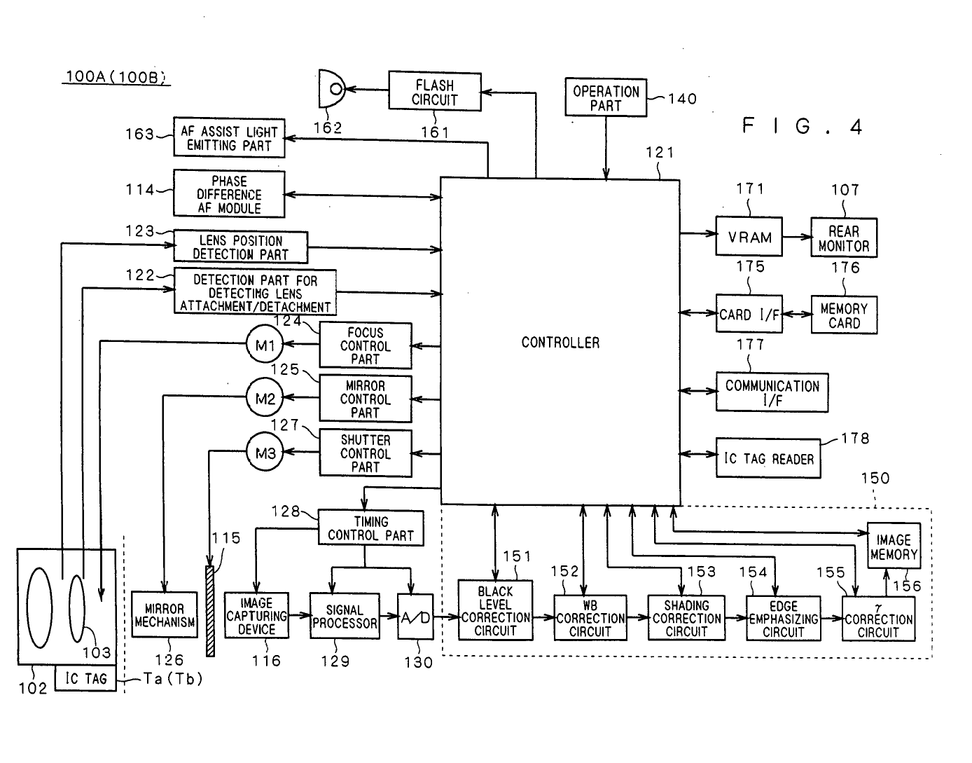

FIGS. 1 and 2 are external views of an image capturing system 100A according to a first preferred embodiment of the present invention. FIGS. 1 and 2 are respectively external front and external rear views of the image capturing system 100A. FIG. 3 is a sectional view with respect to III-III of FIG. 1.

With reference to FIG. 1, the image capturing system 100A is a single-lens reflex digital still camera comprising a camera body 101, and an interchangeable lens 102 detachably attached approximately to the center as viewed from the front.

With reference to FIG. 1, the camera body (imaging capturing apparatus) 101 has a mount Mt provided approximately at the center as viewed from the front for holding an interchangeable lens, a button 149 provided near the mount Mt for attaching and detaching an interchangeable lens to and from the mount Mt, a grip 105 provided on the left end as viewed from the front and held by a user, and an AF assist light emitting part 163 for emitting assist light for autofocus.

The camera body 101 also has a control value setting dial 146 at the upper right as viewed from the front for setting control values, a mode setting dial 142 at the upper left as viewed from the front for permitting switching among recording modes, a release button 147 on the upper surface of the grip 105 for instructing start of exposure, and a flash unit 162 for emitting light for exposing a subject to light in flash photography. Electric contacts EC and a coupler MC are provided near the mount Mt that respectively make electrical and mechanical connections to the interchangeable lens 102 attached to the mount Mt are provided near the mount Mt.

The electric contacts EC serve to read information stored in a lens ROM (read-only memory) built in the interchangeable lens 102 that is unique to the interchangeable lens 102 (including full-aperture F value and focal length), and transmit this information to an overall controller 121 in the camera body 101. The electric contacts EC further serve to transmit the position of a focusing lens 103 in the interchangeable lens 102 to the overall controller 121.

As discussed, the interchangeable lens 102 is provided with a lens ROM that stores information unique to the interchangeable lens 102. The interchangeable lens 102 is also provided with an IC tag Ta storing information unique to the interchangeable lens 102 and different from the information stored in the lens ROM. The IC tag Ta is affixed to the interchangeable lens 102 at a predetermined position such as rear surface of a zoom ring. The IC tag Ta stores information about shading correction (which will also be referred to as “shading data”) of the interchangeable lens 102.

The coupler MC serves to transmit the driving force of a motor M1 provided in the camera body 101 for driving a focusing lens to a lens drive mechanism 104 arranged in the interchangeable lens 102. The focusing lens 103 is caused to move along an optical axis LX by the action of the lens drive mechanism 104.

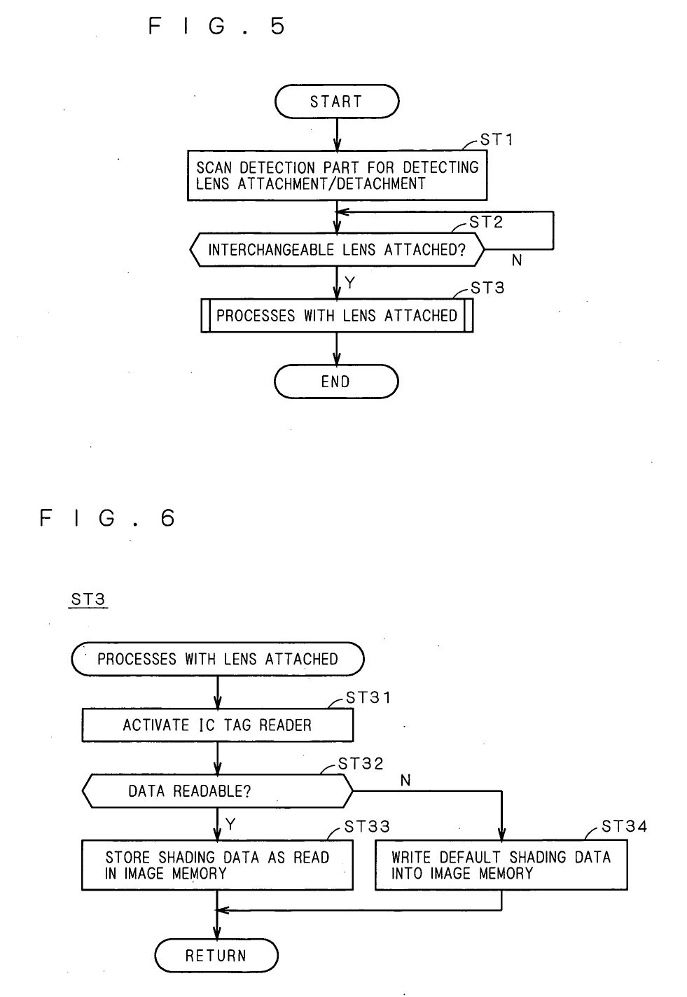

With reference to FIG. 1, battery and card compartments are arranged inside the grip 105. As an example, four AA cells as a power source for a camera are stored in the battery compartment. A memory card 176 (see FIG. 4) storing image data of captured images is detachably attached in the card compartment.

The mode setting dial 142 permits switching among various modes of a camera (including still image recording mode for taking still images, moving image recording mode for capturing moving images, playback mode for playing back captured images, communication mode for permitting data communication to and from an external device and the like).

The release button 147 is a two-stage switch capable of being switched between “half-pressed state S1” in which the release button 147 is pressed halfway down, and “fully-pressed state S2” in which the release button 147 is fully depressed. The half press of the release button 147 in the still image recording mode triggers preparatory work for capturing a still image of a subject (including setting of exposure control values, focusing and the like). The full press of the release button 147 triggers capturing operation (a series of operations including exposure of a to-be discussed image capturing device 116 to light, predetermined image processing upon an image signal obtained from the exposure, and recording of a resultant signal into the memory card 176).

With reference to FIG. 2, a finder window 108 is provided approximately at the upper center of the rear side of the camera body 101. An image of a subject passing through the interchangeable lens 102 is guided to the finder window 108. A user is allowed to visually recognize a subject through the finder window 108. More specifically, an image of a subject after passing through the interchangeable lens 102 is reflected upward by a mirror mechanism 126 (see FIG. 4), thereby forming an image of the subject on a focal plane plate. Via reflections in a pentaprism, the image appears in an eyepiece to be visually recognized by the user. The finder window 108 includes a built-in liquid crystal display showing various types of information indicative for example of shutter speed, aperture value and other conditions of the image capturing system 100A. Thus the user is allowed to see various conditions of the image capturing system 100A through the finder window 108.

A rear monitor 107 is provided approximately at the center of the rear side of the camera body 101. The rear monitor 107 may for example be a color liquid crystal display. The rear monitor 107 shows menu screens for setting modes related to exposure control and shooting scene, and for setting shooting conditions under each recording mode, for example. The rear monitor 107 also shows a playback of a captured image stored in the memory card 176 in the playback mode.

A main switch 141, configured as a two-position slide switch, is provided to the upper left of the rear monitor 107. The main switch 141 at the “OFF” position on the left turns the camera off, whereas the main switch 141 at the “ON” position on the right turns the camera on.

A direction selection button 144 with a circular operation button is provided to the right of the rear monitor 107. Four presses in up, down, right and left directions, and four presses in upper-right, upper left, lower right and lower left directions of the circular operation button are detected. In addition to these presses in eight directions, the press of a push button at the center is also detected.

A group of setting buttons 143 including a plurality of buttons are provided under the rear monitor 107. The group of setting buttons 143 serves to set up menu screen, delete images and the like.

FIG. 4 is a functional block diagram of the image capturing system 100A.

In the image capturing system 100A, the controller 121 serves to function as a main microcomputer responsible for overall control of the image capturing system 100A in response to instructions given from a user through an operation part 140, the position of the focusing lens 103 detected by a lens position detection part 123 and the like.

The operation part 140 includes the foregoing main switch 141, mode setting dial 142, group of setting buttons 143, release button 147 and the like.

The controller 121 causes the lens position detection part 123 to detect the position of the focusing lens 103 in the interchangeable lens 102. The controller 121 causes a focus control part 124 to control the motor M1, thereby driving the focusing lens 103 in the interchangeable lens 102. In the image capturing system 100A, the focusing lens 103 is caused to move based on the amount of defocus obtained by a phase difference AF module 114, thereby realizing focusing.

The controller 121 causes a detection part 122 for detecting lens attachment/detachment to see whether the interchangeable lens 102 has been attached to the mount Mt. As an example, it is determined whether the information stored in the lens ROM built in the interchangeable lens 102 can be read out by the controller 121 through the electric contacts EC (FIG. 3), and the result of which is used to detect the attachment of the interchangeable lens 102.

The controller 121 causes a mirror control part 125 to control a motor M2, thereby driving for example a quick return mirror in the mirror mechanism 126.

The controller 121 causes a shutter control part 127 to control a motor M3, thereby driving a shutter 115.

The controller 121 causes a timing control circuit 128 to control the image capturing device 116 which for example forms a CCD, a signal processor 129 and an A/D converter 130.

An image captured by the image capturing device 116 is converted to image data by the signal processor 129 and A/D converter 130, and is then sent to the image processor 150. The image data thereby obtained in the image processor 150 is subjected to image processing at a black level correction circuit 151, a WB correction circuit 152, a shading correction circuit 153, an edge emphasizing circuit 154 and a γ correction circuit 155, and is then stored in an image memory 156 in the image processor 150.

The image data after being subjected to the processing at the image processor 150 may be displayed on the rear monitor 107 through a VRAM 171, stored in the memory card 176 through a card I/F 175, or transmitted to the outside through a communication I/F 177 standardized for example as USB.

The controller 121 causes a flash circuit 161 to activate the flash unit 162 or activate the AF assist light emitting part 163 as needed.

The controller 121 is capable of reading the shading data stored in the IC tag Ta affixed to the interchangeable lens 102 by radio communication through an IC tag reader 178. The shading correction circuit 153 uses the shading data read out from the IC tag Ta to perform shading correction corresponding to the interchangeable lens 102 with a high degree of accuracy (the detail of which will be discussed later). When the shading data cannot be obtained from the IC tag Ta, default shading data stored in the controller 121 may be applied for use in shading correction, for example.

Next, it will be discussed how the image capturing system 100A with the foregoing configuration operates.

<Operation of Image Capturing System 100A>

FIG. 5 is a flow chart showing the basic operation of the image capturing system 100A realized by the controller 121.

When a user actuates the main switch 141 to turn the system on, the controller 121 performs initialization for startup and scans the detection part 122 (step ST1).

In step ST2, it is determined using the detection part 122 whether the interchangeable lens 102 has been attached to the camera body 101. When the interchangeable lens 102 has been attached, the flow proceeds to step ST3. When the interchangeable lens 102 has not been attached, step ST2 is repeated.

Step ST3 is allocated for processes with a lens attached discussed below.

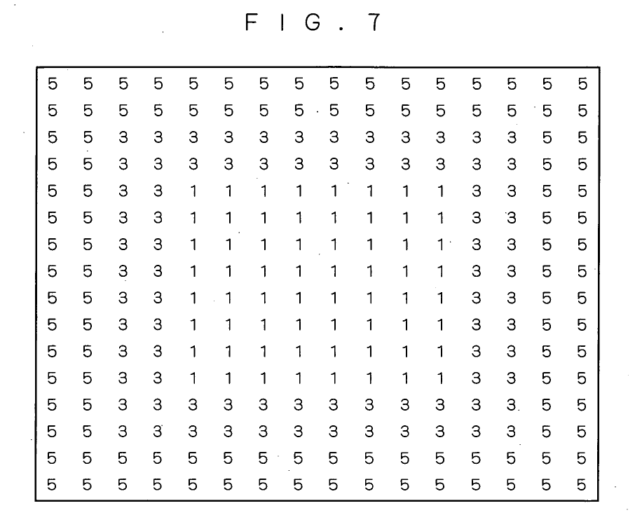

FIG. 6 is a flow chart showing the flow of processes with a lens attached corresponding to step ST3 discussed above.

In step ST31, the IC tag reader 178 is activated.

In step ST32, it is determined whether the IC tag reader 178 is capable of reading the data stored in the IC tag Ta. When data reading is judged as being possible, the flow proceeds to step ST33. When data reading is judged as being impossible as a result of lack of IC tag in the interchangeable lens 102, for example, the flow proceeds to step ST34.

In step ST33, the shading data read out from the IC tag Ta by the IC tag reader 178 is stored in the image memory 156.

In step ST34, the default shading data is written into the image memory 156.

When the image data taken by the image capturing device 116 is transmitted through the WB correction circuit 152 to the shading correction circuit 153, the shading data written into the image memory 156 in step ST33 or ST34 is sent through the controller 121 to the shading correction circuit 153 for use in shading correction. Such use of the shading data (correction information) stored in the IC tag Ta for shading correction allows a high degree of accuracy in performing correction corresponding to the interchangeable lens 102.

The foregoing processes with a lens attached are not necessarily performed immediately after turn-on of the camera body 101 with the interchangeable lens 102. These processes may be preformed when the interchangeable lens 102 is attached to the camera body 101 already in ON state.

As discussed, in the image capturing system 100A, the shading data of the interchangeable lens 102 is read out by the IC tag reader 178 from the IC tag Ta affixed to the interchangeable lens 102. Thus shading correction corresponding to an interchangeable lens can be facilitated. Even when the shading data of the interchangeable lens 102 is not stored in a lens ROM or the like at the time of manufacture of the interchangeable lens 102 (when an interchangeable lens for a film camera is used in a digital camera, for example), only the affixation of the IC tag Ta storing the shading data of the interchangeable lens 102 will provide a high degree of accuracy in shading correction.

### Second Preferred Embodiment

An image capturing system 100B according to a second preferred embodiment of the present invention has a similar configuration to that of the image capturing system 100A of the first preferred embodiment described in FIGS. 1 through 4, with the exception of the structure of an IC tag.

More specifically, an IC tag Tb affixed to the interchangeable lens 102 in the image capturing system 100B stores correction information about the field curvature of the interchangeable lens 102 (which will also be referred to as “field curvature data”).

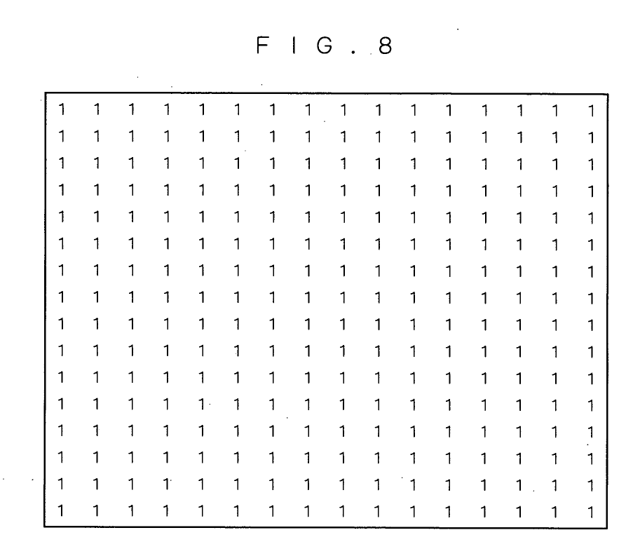

When an image is captured by the interchangeable lens 102 with field curvature, the center of the image is properly focused whereas the edge portion of the image is out of focus. Then the area including this edge portion of the image is subjected to sharpening at the edge emphasizing circuit 154, for which the field curvature data of the interchangeable lens 102 shown for example in FIG. 7 is stored in the IC tag Tb. This field curvature data is constituted as a 16 by 16 matrix of elements, with the elements being given higher numbers that are intended to indicate that particular edge emphasis is desired at the corresponding portion. When an image to be subjected to field curvature correction is for example of 640×480 pixels, each element constituting the matrix covers an area of 40×30 pixels.

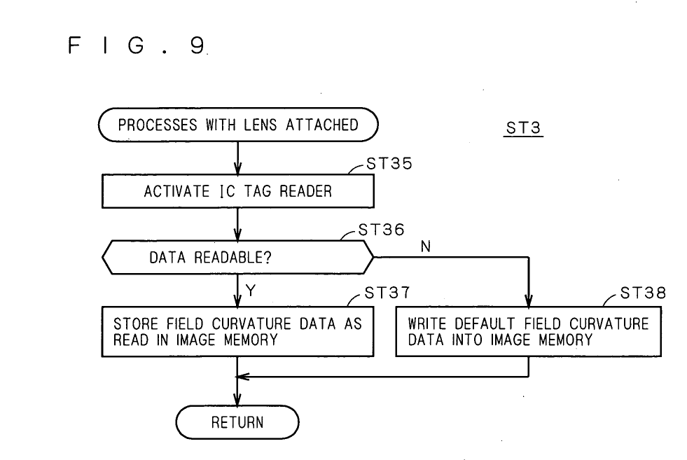

When an IC tag is not affixed to the interchangeable lens 102 as discussed below, default field curvature data stored in the controller 121 (shown in FIG. 8) may be used to perform edge emphasis at the edge emphasizing circuit 154, for example. Like the field curvature data shown in FIG. 7, the default field curvature data of FIG. 8 is constituted as a 16 by 16 matrix of elements. However, each element is given the same number “1”.

<Operation of Image Capturing System 100B>

The image capturing system 100B with the foregoing configuration operates in a manner similar to that of the image capturing system 100A shown in the flow chart of FIG. 5, with the exception of step ST3 allowed for processes with a lens attached.

FIG. 9 is a flow chart showing the flow of processes with a lens attached in the image capturing system 100B.

In steps ST35 and ST36, the same processes as those of steps ST31 and ST32 are followed.

In step ST37, the field curvature data read out from the IC tag Tb (see FIG. 7) by the IC tag reader 178 is stored in the image memory 156.

In step ST38, the default field curvature data (see FIG. 8) is written into the image memory 156.

When the image data taken by the image capturing device 116 is transmitted to the edge emphasizing circuit 154, the field curvature data written into the image memory 156 in step S37 or S38 is sent through the controller 121 to the edge emphasizing circuit 154 for use in field curvature correction. Such use of the field curvature data (correction information) stored in the IC tag Tb for field curvature correction allows a high degree of accuracy in performing correction corresponding to the interchangeable lens 102.

The foregoing processes with a lens attached are not necessarily performed immediately after turn-on of the camera body 101 with the interchangeable lens 102. These processes may be performed when the interchangeable lens 102 is attached to the camera body 101 already in ON state.

As discussed, in the image capturing system 100B, the field curvature data of the interchangeable lens 102 is read out from the IC tag Tb affixed to the interchangeable lens 102 by the IC tag reader 178. Thus field curvature correction corresponding to an interchangeable lens can be facilitated. Even when the field curvature data of the interchangeable lens 102 is not stored in a lens ROM or the like at the time of manufacture of the interchangeable lens 102 (when an interchangeable lens for a film camera is used in a digital camera, for example), only the affixation of the IC tag Tb storing the field curvature data of the interchangeable lens 102 will provide a high degree of accuracy in field curvature correction.

<Modifications>

The IC tag affixed to an interchangeable lens in each of the first and second preferred embodiments does not necessarily store shading data or field curvature data. As an example, other correction information such as that for spherical aberration may be stored in the IC tag.

While the invention has been shown and described in detail, the foregoing description is in all aspects illustrative and not restrictive. It is therefore understood that numerous modifications and variations can be devised without departing from the scope of the invention.

What is claimed is:

1. An image capturing system, comprising:
(a) an interchangeable lens provided with an IC tag storing specific information; and
(b) an image capturing apparatus to and from which said interchangeable lens can be attached and detached, said image capturing apparatus including
a reader for reading said specific information from said IC tag, and
a processor responsible for predetermined processing based on said specific information read by said reader.

2. The image capturing system according to claim 1, wherein
said specific information is correction information of said interchangeable lens, and
said processor includes a correcting part responsible for correction based on said correction information.

3. The image capturing system according to claim 2, wherein
said correction information relates to shading correction.

4. The image capturing system according to claim 2, wherein
said correction information relates to field curvature correction.

5. The image capturing system according to claim 2, wherein
said IC tag is affixed to a predetermined part of said interchangeable lens.

6. An interchangeable lens capable of being attached to and detached from an image capturing apparatus, comprising:
(a) a body; and
(b) an IC tag provided to said body and storing specific information,
said image capturing apparatus including
a reader for reading said specific information from said IC tag, and
a processor responsible for predetermined processing based on said specific information read by said reader.

7. The interchangeable lens according to claim 6, wherein
said specific information is correction information of said interchangeable lens, and
said processor includes a correcting part responsible for correction based on said correction information.

8. The interchangeable lens according to claim 7, wherein
said correction information relates to shading correction.

9. The interchangeable lens according to claim 7, wherein
said correction information relates to field curvature correction.

10. The interchangeable lens according to claim 6, wherein
said IC tag is affixed to a predetermined part of said body.

11. An image capturing apparatus to and from which an interchangeable lens can be attached and detached, comprising:
(a) a reader for reading specific information from an IC tag; and
(b) a processor responsible for predetermined processing based on said specific information read by said reader,
said IC tag storing said specific information being provided to said interchangeable lens.

12. The image capturing apparatus according to claim 11, wherein
said specific information is correction information of said interchangeable lens, and
said processor includes a correcting part responsible for correction based on said correction information.

13. The image capturing apparatus according to claim 12, wherein
said correction information relates to shading correction.

14. The image capturing apparatus according to claim 12, wherein
said correction information relates to field curvature correction.

15. The image capturing apparatus according to claim 11, wherein
said IC tag is affixed to a predetermined part of said interchangeable lens.

16. An IC tag, comprising:
(a) a storage part storing specific information; and
(b) a transmission part for transmitting said specific information to outside,
said IC tag being provided to an interchangeable lens capable of being attached to and detached from an image capturing apparatus, said image capturing apparatus including
a reader for reading said specific information from said IC tag, and
a processor responsible for predetermined processing based on said specific information read by said reader.

17. The IC tag according to claim 16, wherein
said specific information is correction information of said interchangeable lens, and
said processor includes a correcting part responsible for correction based on said correction information.

18. The IC tag according to claim 17, wherein
said correction information relates to shading correction.

19. The IC tag according to claim 17, wherein
said correction information relates to field curvature correction.

20. The IC tag according to claim 16, wherein
said IC tag is affixed to a predetermined part of said interchangeable lens.
